(19) United States
(12) Patent Application Publication
(10) Pub. No.: US 2003/0061828 A1
(43) Pub. Date: Apr. 3, 2003

(54) Air conditioner with battery power source

(76) Inventor: Jerry L. Blevins, Toms Brook, VA (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 10/231,337

(22) Filed: Aug. 30, 2002

Related U.S. Application Data
(60) Provisional application No. 60/316,023, filed on Aug. 31, 2001.

(51) Int. Cl. H02J 1/00; F25B 27/00

(52) U.S. Cl. 62/236; 307/39

(57) ABSTRACT

The air conditioning system can draw power from the utility power grid via an electrical line or from a battery. When the air conditioner is used during off peak hours, the air conditioner will draw power directly from the power grid. During peak usage, the air conditioner will be provided with power from the battery. The battery, in turn, is recharged from the power grid during off peak hours, such as during the night. In this way, the battery is kept fully charged and able to provide power during the peak period. The flow of the power to the air conditioner from the battery or line power is controlled by a timer switch. The flow of line power to the air conditioner or battery recharger during off peak hours is controlled by a recharge timer switch. The result is an air conditioning system reducing the strain on the power grid during peak usage and having an alternative power source, the battery, charged during off peak hours.

This application claims the benefit of provisional application Serial No. 60/316,023, filed Aug. 31, 2001.

### FIELD OF THE INVENTION

The invention relates to an air conditioning system having a battery power source for use during peak electrical usage.

### BACKGROUND OF THE INVENTION

A large part of the cost in supplying power is the infrastructure including power stations, sub-stations, transformers and power lines to supply power from the power generating source to customers. The system needs to be designed to carry the peak usage at any given time. The time of peak usage depends on various factors such as special events in the area and prevailing weather conditions. Peak usage during the summer usually occurs in the early evening when both businesses are operating and people arrive home and use energy, particularly in the form of air conditioners.

During extreme peaks in usage, brown-outs are used when the power company intentionally denies power to users to prevent an overload of the system. During such brown-outs, the customers are denied power and cannot use any of the many appliances dependent on electricity. This condition is a frustration to customers but is necessary to insure the continued operation of the electrical grid system.

One solution to the problem has been for the utility companies to offer cheaper electricity rates an night. This encourages users, particularly businesses, to switch energy using processes to the night, if possible. This reduces the peak usage and prevents the need to increase the energy infrastructure.

During the summer months, peak usage can be attributed to the widespread use of air conditioners, all of which use electricity to cool homes and businesses. Any ability to alleviate the energy drain for the operation of air conditioners would reduce the utility company's peak usage.

The use of alternative sources of energy for air conditioning systems has been explored in the prior art. The patent to Kobayashi et al (U.S. Pat. No. 5,200,644) discloses a commercial air conditioning unit having a battery for supplying power to the air-conditioner to alleviate the voltage drop when the machine starts or when the power company is low. Another prior patent to Wilhelm (U.S. Pat. No. 5,969,435) discloses the use of a battery to help power an air conditioner at the air conditioner's peak load, not the power company's peak load, and during emergencies. The patent to Liberto et al (U.S. Pat. No. 4,349,148) discloses a direct current power back up for the fan of a heating system in the eventuality of a power interruption.

There is a need in the prior art for a system allowing air conditioner operate from a power source other than the power provided from a utility company line and that shifts the energy uses to off peak hours, such as during the night.

It is an object of the invention to provide an air conditioner system having power supplied from a utility power grid or a battery.

It is another object of the invention to provide an air conditioning system having a timer switch controlling the power source supplying an air conditioning system.

It is yet another object of the invention to provide an air conditioning system having a battery power supply which is recharged during off peak usage hours.

It is another object of the invention to provide an air conditioning system which reduces the strain on an electrical grid during peak hours.

It is another object of the invention to provide an air conditioning system having an alternative power source for peak usage hours that is simple and inexpensive to use.

These and other objects of the invention will become apparent to one of ordinary skill in the art after reviewing the disclosure of the invention.

### SUMMARY OF THE INVENTION

The air conditioning system can draw power from the utility power grid via an electrical line or from a battery. When the air conditioner is used during off peak hours, the air conditioner will draw power directly from the power grid. During peak usage, the air conditioner will be provided with power from the battery. The battery, in turn, is recharged from the power grid during off peak hours, such as during the night. In this way, the battery is kept fully charged and able to provide power during the peak period. The flow of the power to the air conditioner from the battery or line power is controlled by a timer switch. The flow of line power to the air conditioner or battery recharger during off peak hours is controlled by a recharge timer switch. The result is an air conditioning system reducing the strain on the power grid during peak usage and having an alternative power source, the battery, charged during off peak hours.

### BRIEF DESCRIPTION OF THE DRAWINGS

FIG. 1 is a flow chart describing the operation of the system;

FIG. 2 is a schematic drawing showing the use of the air conditioner during the off peak period;

FIG. 3 is a schematic drawing of the battery being charged during off peak hours; and

FIG. 4 is a schematic drawing of the air conditioner receiving power from the battery during peak hours.

### DETAILED DESCRIPTION OF THE INVENTION

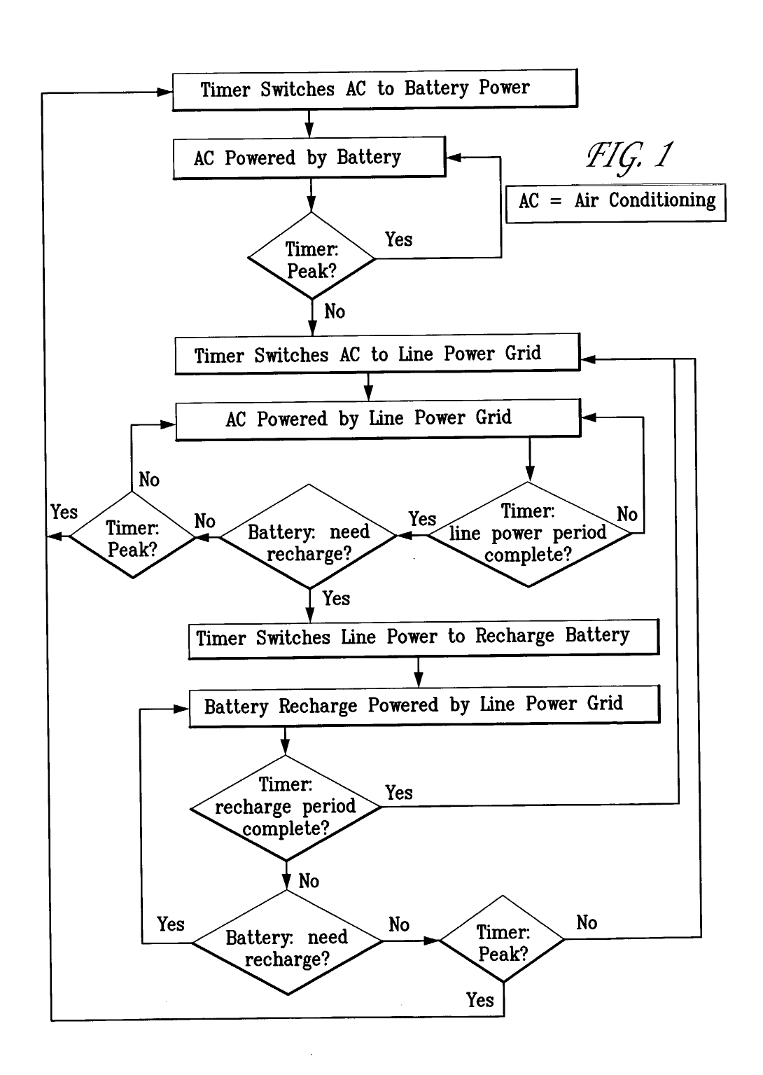

With reference to FIG. 1, the operation of the invention will be described. A peak timer switch that is part of the system controls the flow of energy through the system. When the timer indicates that it is a period of peak usage, the timer causes a switch to power the air conditioning by the battery. During other times, the air conditioner will be powered by electricity supplied by the power grid. During a pre-set, off peak time period, a recharge timer causes a switch to connect the power grid power line to the battery recharger to maintain a full charge. During the recharge period, if the battery needs to be recharged, the power is supplied through the battery recharger to the battery. If during this time, the battery does not need to be recharged, the power from the power grid is connected to the air conditioner.

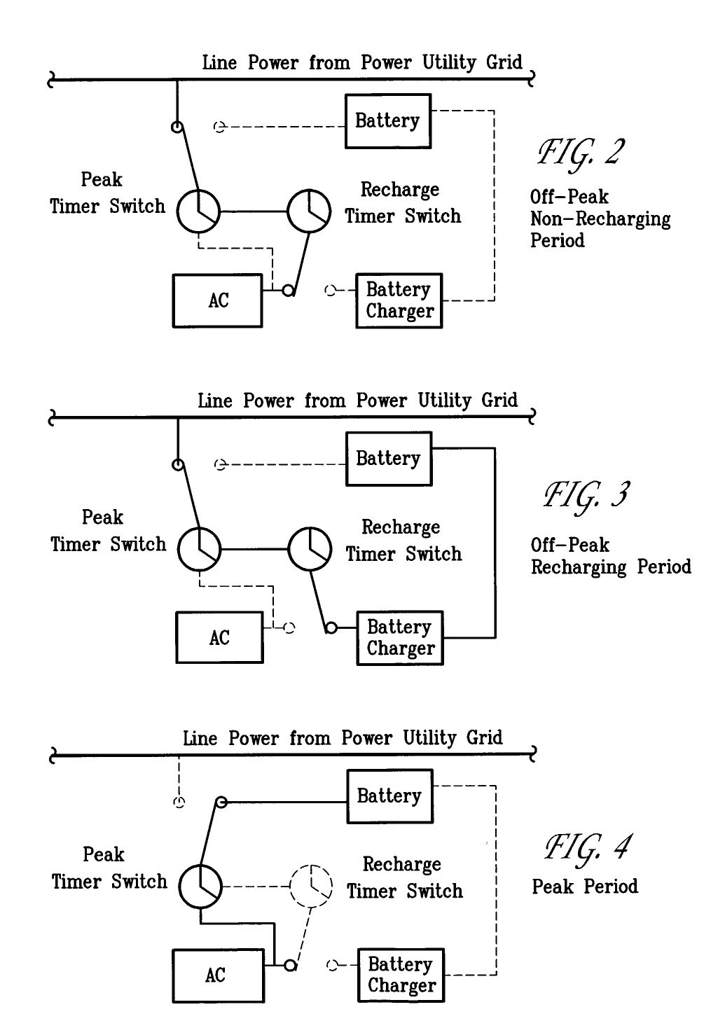

The timers determine which one of three circuits is utilized. Each of the circuits is depicted in FIGS. 2-4. Each of these circuits will now be described.

FIG. 2 depicts the off peak, non-recharging period. In this mode, power supplied from the utility grid passes through the peak timer switch set in the off peak position. In this position, power flows through the switch to the recharged timer switch. As long as the recharge timer switch indicates that the battery does not need to be recharged, power is supplied to the air conditioner. In this mode, the air conditioner runs as a normal air conditioner system.

FIG. 3 depicts the off peak recharging period. Similar to the off peak non-recharging period, the peak timer switch allows power to flow from the power grid. However, in this mode, the recharged timer switch provides power to a battery charger, not the air conditioner. This allows the battery to maintain a full charge so that it may provide battery to the air conditioner when needed. While the peak timer switch is set to a preset time corresponding to the time of peak usage for the electrical power grid, the recharged timer switch is set for a time when the air conditioner is not likely to be used. This time is particularly the coolest part of the day, just before dawn. In this way, the battery can be charged without the users of the air conditioner realizing that the air conditioner is not being provided with power. Besides being time dependent, the recharge timer switch can be used to switch to the off peak non-recharging period when the battery does not need a charge. In this way, power is supplied to the battery only during a specific time of day and only when needed.

FIG. 4 shows the air conditioner circuit during times of peak usage of the power grid. At these times, usually corresponding to 4:00-6:00PM, the air conditioner is supplied exclusively with power from the battery. As can be seen in FIG. 4, the line power from the utility grid is not used in any manner and the air conditioner does not place any demands on the utility grid.

The system allows the air conditioner to continue operating when most needed, during peak periods, but not place any strain on the utility power grid. The battery is recharged during a convenient time so that the users of the air conditioners do not realize that it is not being provided with power. This time is very early in the morning when the usage is at a minimum. The result is the switching of power demand from a period of peak usage to a period of low usage. In the event of an overload of the power grid and the use of brown-outs by the utility company, an air conditioner utilizing the system of the invention will continue to operate.

While the invention has been described with reference to a preferred embodiment, variations and modifications would be apparent to one of ordinary skill in the art and such variations and modifications are well within the scope of the invention.

I claim:

1. An air conditioning system, comprising:
an air conditioning unit,
a power line connected to the air conditioning unit for supplying electricity to the air conditioning unit from a power grid,
a battery for supplying electricity to the air conditioning unit,
a timer switch controlling the flow of electricity from either said power line or said battery.

2. The air conditioning system of claim 1,
further comprising a recharge timer switch for supplying electricity from said power line to said air conditioner unit or a battery recharger.

3. The air conditioning system of claim 1, wherein
said timer switch supplies electricity from said battery at timer of peak electrical usage.

4. The air conditioning system of claim 2, wherein
said recharge timer switch supplies electricity to said battery recharger when said battery needs to be recharged.

5. A method of operating an air conditioning system, comprising:
supplying power to an air conditioner unit from a power line connected to a power grid during off peak electrical usage house, and
supplying power to said air conditioner unit from a battery during peak electrical usage hours.

6. The method of claim 5, wherein
a timer switch controls the supply of power from either said power lien or said battery.

7. The method of claim 5, further comprising
supplying power from said power line to a battery recharger during said off peak hours for recharging said battery.

8. The method of claim 7, wherein
a recharge timer switch controls the flow of power from said power line to said air conditioner unit or said battery charger.
